(19) United States
(12) Patent Application Publication
(10) Pub. No.: US 2011/0224828 A1
(43) Pub. Date: Sep. 15, 2011

(54) DEVELOPMENT PLATFORM FOR ROBOTIC SYSTEMS

(75) Inventors: Robert S. Breznak, Somerville, MA (US); Alexander V. Camilo, Worcester, MA (US); Kevin J. Harrington-Rutter, Worcester, MA (US)

(73) Assignee: Neuron Robotics, LLC, Somerville, MA (US)

(21) Appl. No.: 13/026,731

(22) Filed: Feb. 14, 2011

Related U.S. Application Data
(60) Provisional application No. 61/304,107, filed on Feb. 12, 2010.

(51) Int. Cl. G06F 19/00

(52) U.S. Cl. 700/264; 700/245

(57) ABSTRACT

A unified system for development of robotics and other cyber-physical systems is discussed. The unified system includes a platform that integrates the processing of actuators and sensors and other modules. The platform is inter-operable into many existing systems. Various modules are developed to do discrete tasks that are commonly found in robotics such as moving motors or reading and controlling sensors. The modules communicate with each other and with other devices such as computers and user built modules through the use of a commonly supported abstract communication protocol.

### RELATED APPLICATIONS

This application claims the benefit of provisional patent application U.S. Ser. No. 61/304,107, filed Feb. 12, 2010, the contents of which are hereby incorporated by reference.

### FIELD OF THE INVENTION

The present invention relates to a framework for robotics development that allows robotic system designers with varying areas of expertise to rapidly deploy robotic systems for industry, research and education.

### BACKGROUND INFORMATION

Robotics development projects utilize many different sensors and actuators that are available to the robotics community. At the lowest level, component-level sensors that interface directly with microcontrollers are available from many semiconductor companies. Each device has its own particular interface and traits that must be considered in interacting with the sensors. Actuators present a similar case where there is an abundance of different motors and motor controllers each with its own interface. Other actuators requiring controllers include hydraulics, pneumatics, shape memory alloy (SMA), electroactive polymers (EAPs), and the like.

Robotics development projects also utilize many different types of microcontrollers. The speed of the microcontrollers may be an issue if any complicated computation is needed. The most common type of microcontroller is relatively slow running at around 10 MHz and is of an 8-bit architecture. Some other microcontrollers are faster but do not approach the raw processing power of a simple modern desktop computer with its multi-core, superscalar, cached, pipelined, GHz-class processor and variety of available software. Accordingly, a microcontroller in robotics most often performs simple low-level calculations repetitively and manages digital inputs and outputs.

Integrated robotics development systems attempt to identify any difficulties in programming and using microcontrollers and endeavor to make them easier to use by abstracting some of the development from the user. The integrated robotics development systems provide support circuitry, power management and libraries of functions that provide access to features of the microcontrollers. Examples of systems that fit into this category include the Arduino and the VEX™ development system from Innovation First, Inc.

Robotics development systems may also provide hardware abstraction over a known protocol. These devices or systems attempt to provide access to robotic elements, such as sensors and actuators, using a defined protocol and an interface that a generic operating system can use.

One class of hardware abstraction is the group of systems that abstract over TCP/IP. Examples of such systems include the National Instruments (Austin, Tex.) cRIO® data acquisition systems, Willow Garage (Menlo Park, Calif.) Player® system, and Galil (Rocklin, Calif.) motion controllers, all of which are robotics development platforms. In addition, protocols such as the OpenIGTLink have been developed to provide a common interface for custom robotic hardware with a specific focus on medical robotics.

Robotics development systems may also utilize a robotic control framework that runs at the operating system level. This is the level at which many researchers are either developing or require custom software for evaluation of robotic system components. Two existing frameworks are widely used in the robotics community. MATLAB from the MathWorks Inc. of Natick, Mass. is often used as a research interface, while National Instruments' LabView® provides an integrated device interface. These products are commonly used among developers who are looking to demonstrate a set of algorithms and its interaction to the world. Related robotics frameworks include the Willow Garage Robot Operating System (RoS), Microsoft Robotics Studio (MRS) (Redmond, Wash.), and OROCOS.

### SUMMARY

The embodiments of the present invention provide a common, modular framework that allows iterative and independent development of electro-mechanical systems. The framework provides a development platform for development of robotics and other cyber-physical devices. The platform includes one or more libraries of module objects defining functionality for associated robotic and/or other device modules. The objects provide support for the use of an abstract communication protocol for communicating with and between device modules. By incorporating a multi-language, multi-platform device interface into a community development environment, users can focus their research on their area of expertise and leverage developments in other sectors.

According to one embodiment of the present invention, a system for robotics development is provided. The system includes a computing device generated platform for development of a robotics device and an abstract communication protocol used to control hardware components for the robotics device. The platform includes one or more libraries holding robotic device module objects. The robotic device module objects define functionality of associated robotic device modules. The robotic device module objects include objects associated with at least two different types of robotics device modules and hold information for communicating with their respective associated robotics device modules. The abstract communication protocol is supported by instances of the robotic device module objects and interconnects the platform and the robotic device modules. The abstract communication protocol supports communication over different types of physical layer connections and further supports communication between robotics device modules using different types of network transport layer protocols. The robotic device modules respectively control hardware components in the robotics device.

According to an embodiment of the present invention, a method for operating a robotics development system is provided. The method includes providing a platform for development of a robotics device. The platform includes one or more libraries and an abstract communication protocol. The libraries hold robotic device module objects defining functionality of associated robotic device modules. The abstract communication protocol is supported by instances of the robotic device module objects and interconnects the platform and the robotic device modules of the robotics device. The abstract communication protocol supports communication over different types of physical layer connections and further supports communication between robotic device modules using different types of network transport layer protocols. The method further includes designating with the platform a host to control at least one robotics device module in the robotics device that is designated as a node. The method also includes receiving at the host a communication from the node, the communication using the abstract communication protocol and describing an interface for the node. A command is transmitted from the host to the node, the command directed to a hardware component associated with the node. The method further includes receiving, at the host, a result of an attempted execution of the command from the node.

According to various embodiments of the present invention, a method for performing unit testing in a robotics development system is provided. The method includes providing a platform for development of a robotics device. The platform includes one or more libraries and an abstract communication protocol. The libraries hold robotic device module objects defining functionality of associated robotic device modules. The abstract communication protocol is supported by instances of the robotic device module objects and interconnects the platform and the robotic device modules of the robotics device. The abstract communication protocol supports communication over different types of physical layer connections and further supports communication between robotic device modules using different types of network transport layer protocols. The method further designates with the platform a host to control at least one robotics device module in the robotics device. At least one robotics device module is designated as a node. The node controls a computing resource simulating the performance of virtual hardware component in the robotics device. The method further includes receiving at the host a communication from the node, the communication using the abstract communication protocol and describing an interface for the node. A command is transmitted from the host to the node, the command directed to the virtual hardware component associated with the node. The method further receives, at the host from the node, a result of the simulated execution of the command by the computing resource. The platform is used to evaluate the performance of the virtual hardware component in the robotics device.

According to another embodiment of the present invention, a system for cyber-physical system (CPS) development is provided. The system includes a computing-device generated platform for development of a CPS system and an abstract communication protocol used to control hardware components for the CPS system. The platform includes one or more libraries holding CPS module objects. The CPS module objects define functionality of associated CPS modules. The CPS module objects include objects associated with at least two different types of CPS modules and hold information for communicating with their respective associated CPS modules. The abstract communication protocol is supported by instances of the CPS module objects and used to interconnect the platform and the CPS modules. The abstract communication protocol supports communication over different types of physical layer connections and further supports communication between CPS modules using different types of network transport layer protocols. The CPS modules respectively control hardware components in the CPS system.

### BRIEF DESCRIPTION OF FIGURES

These and other aspects of this invention will be readily apparent from the detailed description below and the appended drawings, which are meant to illustrate and not to limit the invention, and in which:

FIG. 1A illustrates an exemplary integrated development environment according to an embodiment of the present invention where a robotic device module is incorporated in a hardware component;

FIG. 1B illustrates an exemplary distributed system generated using the exemplary integrated development environment illustrated in FIG. 1A;

FIG. 2A illustrates an implementation of the Bowler Communications System (BCS) protocol into the modular, multi-platform, multi-language device interface of the present invention;

FIG. 2B illustrates a system that allows for plug-and-play robotics development through user-developed libraries;

FIG. 3 illustrates a simulated screenshot of an exemplary integrated development environment (IDE) running as a plug-in with the Eclipse® platform according to an aspect of the present invention;

FIG. 4A illustrates an exemplary implementation of the present invention using the EduArm® developed as a low-cost teaching robot;

FIG. 4B illustrates three exemplary modules according to an embodiment of the present invention;

FIG. 5 illustrates a general system overview of the present invention;

FIG. 6A illustrates an exemplary Ethernet module;

FIG. 6B illustrates an exemplary size of the Ethernet module illustrated in FIG. 6A;

FIG. 7 illustrates an exemplary system use case of home monitoring system;

FIG. 8A illustrates an exemplary Dynamic Input/Output module structure;

FIG. 8B illustrates an exemplary size of the Dynamic Input/Output module illustrated in FIG. 8A;

FIG. 8C illustrates an exemplary finished product of Dynamic Input/Output module;

FIG. 9 illustrates an exemplary system use case of home monitoring system with wireless;

FIG. 10 illustrates virtualization according to an embodiment of the present invention;

FIG. 11 illustrates an exemplary implementation of a fish monitoring system using an embodiment of the present invention;

FIG. 12 illustrates the system in FIG. 11 with the addition of an Ethernet routing module;

FIG. 13 illustrates an exemplary wireless embodiment;

FIG. 14 illustrates a home automation using a mix of wired and wireless connections in addition to interfacing with existing hardware;

FIG. 15 illustrates a small robotic arm; and

FIG. 16 illustrates an exemplary module that is compatible with the Bowler Communications System (BCS).

### DETAILED DESCRIPTION

The lack of interoperability and standardized development platforms is a significant impediment to the proliferation of robotics. Robotic system development as conventionally practiced has proved to be a needlessly time consuming and expensive process because each system must be built entirely from the ground up. As specializations emerge within the field of robotics, it is unnecessary and unproductive for researchers, educators, or developers to distract their focus from their primary goal. Ideally, a robotic mechanism designer should be able to develop devices without focusing on software or interfaces, while a software developer should not require a fully functional robotics system to evaluate their implementation. Unfortunately conventional robotics development systems have been lacking in meeting these goals.

The lack of standardization in robotics development also manifests itself in the lack of the ability to verify discrete units of a system. Without this ability, development can be halted by a single misbehaving component which cannot be removed from a system for testing. Development time is wasted tracking down bugs in complex systems. Additionally the lack of a standard framework requires vast development time being spent on creating a virtualization of a system, or making such virtualization prohibitively expensive. Without virtualization and the ability to test units, the developer of robotic systems ends up wasting time on problems that should be detected by a testing framework. In addition to the lack of testing, a developer cannot easily take elements of a project and use them in another project. Code is rarely portable from one type of controller hardware to the next. The lack of portability forces controller-specific code to be written over and over for common tasks, even if the functionality is the same. These tasks are usually not the focus of development, and the result of rewriting this code is wasted time.

Development of a robotic system includes gathering requirements, deciding on a controller that can fulfill the requirements, writing code and making circuits for that controller, as well as designing the physical body around the controller, and testing the system as it is built. If requirements change or tests reveal a problem, all of the controller specific code, electronics, and machining may be lost or haphazardly modified to fit the changed circumstances. There is a need for an infrastructure that allows iterative development of system components with a focus on system integration.

The development of Cyber-Physical systems (CPS) have suffered from some of the same issues. A CPS is an embedded system where the computational elements of the system are in combination and coordination with the physical elements of the system. Unlike more traditional embedded systems, a full-fledged CPS is typically designed as a network of interacting elements with physical input and output instead of as standalone devices. The notion is closely tied to concepts of robotics and sensor networks. For ease of explanation and illustration, much of the below description discusses embodiments of the present invention that are directed to the development of robotics devices. It should be appreciated however that the scope of the present invention is not limited to the development of robotic devices but is also applicable to cyber-physical systems and encompasses the development of CPS devices generally. Accordingly, the techniques discussed herein that apply to the development of robotic devices should also be understood to have applicability to CPS development.

The system for robotics development of the present invention includes a platform that integrates the processing of actuators and sensors discussed above. The platform is inter-operable with many existing systems. The platform allows communication using an abstract communication protocol, such as the Bowler Communications System (BCS) protocol, between various modular processing units, (robotic device modules). The robotic device modules may be connected to the system using a USB, Ethernet or other connection. The Ethernet connection provides portability. For example, a robotic device module that is connected using an Ethernet connection may be used with different kinds of platforms. The modules are developed to do discrete atomic tasks that are commonly found in robotics. For example, an exemplary module may include a motor that moves the robot and/or a reading and controlling sensor. Using the platform, the robotic device modules may communicate with each other and with other devices such as computers and user built modules.

Some exemplary robotic device modules include a servo controller, a general purpose Input/Output module, a DC motor controller module, a range-finder module, a battery regulator/power module, a wireless interface module and an Ethernet interface module. The battery module allows users to have control over power management and the general purpose I/O module allows developers to quickly integrate custom hardware that is added into the system. The wireless and Ethernet interface modules allows users to directly control a module via a computer device over different physical mediums. The exemplary modules are provided for illustrative purposes and should not be construed as limiting.

The exemplary platform enables distributed processing among the robotic device modules without the use of a standard communication path. That is, the network over which the robotic device modules communicate is not required to have a prior knowledge of the capabilities of each robotic device module. The robotic device modules notify the system about their own capabilities. According to various embodiments of the present invention, the robotic device modules communicate their interfaces to the system as opposed to requiring a driver from the system.

The platform and the system provided in the present application significantly reduces the costs that are currently associated with robotics development and therefore opens opportunities for robotics development to a broader audience. The platform and the system include an integrated development environment for general use with robotics; an open, online community for developers to share robotics knowledge and efforts via a common repository, a wide variety of highly documented robotics components for developers to select from; a tested and proven highly extensible communications protocol for robotics components and the basis of an advanced testing framework for unit testing robotics projects. The system can be hooked into at different levels of development and allows designers and researchers to treat everything outside their area of expertise as a black box.

According to another aspect of the invention, an Integrated Development Environment (IDE) that includes examples of multi-language approaches and extensions with industry standard applications such as MATLAB and LabView® is provided. The IDE allows developers to easily develop for compatible hardware utilizing previously generated libraries.

The developed libraries may include elements for sensing and actuation, inter-device communication, low-level device control, and high level control. Due to the modular structure of the system, developers can focus efforts on specific functionality while basing the remainder of the platform on existing, proven software components. The open nature of community development allows for new algorithms, structures, devices, and protocols to be widely distributed to the robotics community and avoid duplication of effort.

By incorporating technologies to automatically detect devices, configure devices, and provide the appropriate API to the developer, an expandable system may be built without knowledge of the specific hardware to be used. In addition, the modularity of the system allows for ease of unit testing and simulation of specific hardware or software components independent of the complete system.

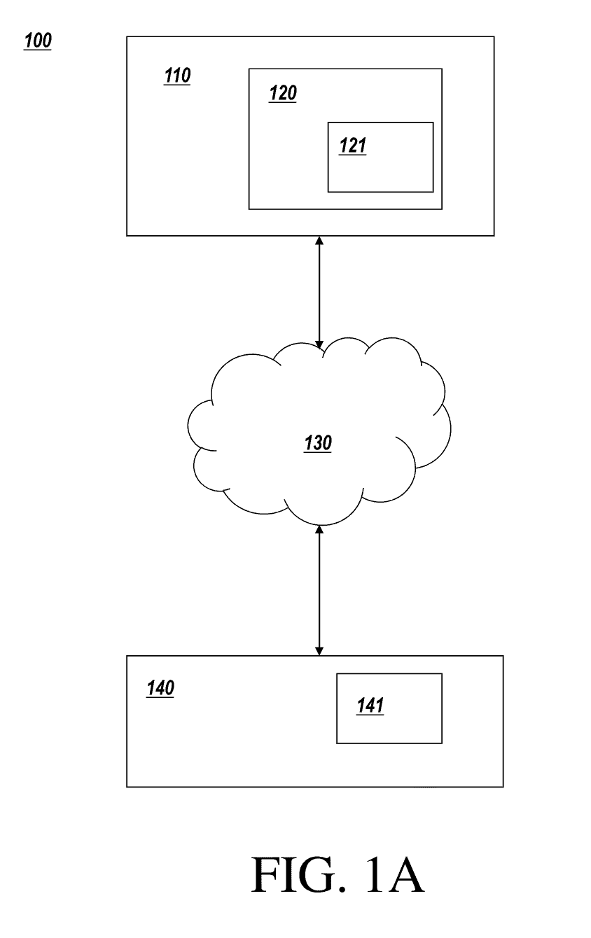

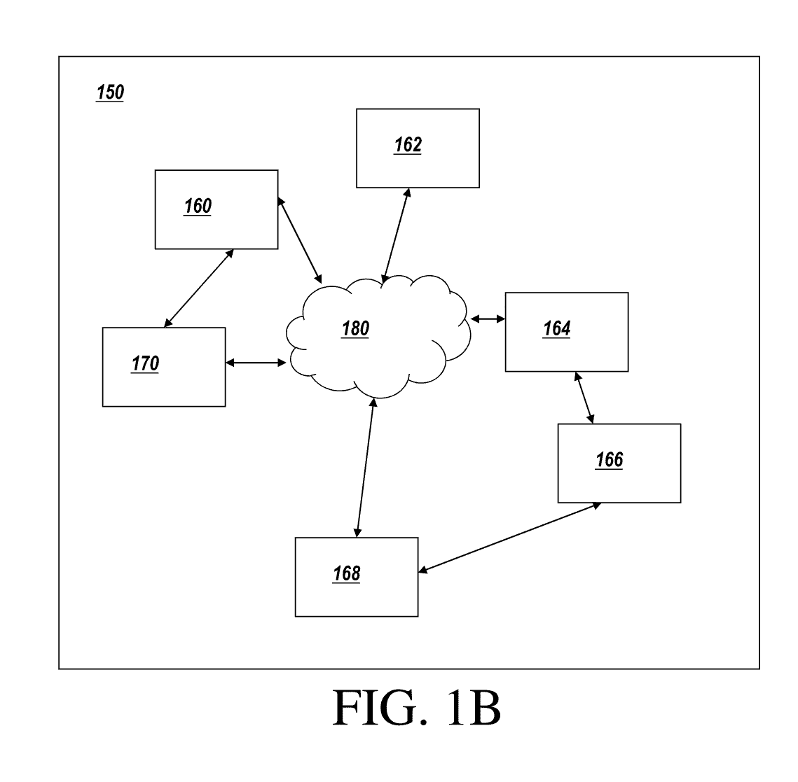

FIG. 1A illustrates an exemplary integrated development environment 100 according to the present invention. The integrated development environment 100 allows the distributed development of a robotics device/system. The integrated development environment 100 includes a platform 110 and hardware components 140. The platform 110 includes a set of libraries 120 that formulate, verify and propagate communications through a set of robotic device module objects 121 provided in the libraries 120. A user may instantiate an instance of the robotic device module objects 121 in order to communicate with and control an associated robotic device module 141 which is in communication with an associated hardware component 140. For example, the user may use the platform 110 to select and instantiate an instance of a DC motor controller module object 121 in the library 120 in order to enable communication and control of a DC motor controller module 141 being utilized to operate a DC motor 140 in a robotic device. It should be appreciated that the hardware component 140 and the module 141 may be integrated or separate components. For example, the module 141 may be a sensor module that is part of an integrated sensor component or the module may communicate in some fashion (e.g. wirelessly or wired) with a detached sensor.

The libraries 120 give the user of the platform 110 the ability to list all connections for the system and then specify messages among components of the distributed robotics device/system 150. The platform 110 uses the library information to automatically find the correct communication route among the components of the distributed robotics device/system 150.

The platform 110 communicates with the modules 141 using an abstract communication protocol that is supported by all instances of the robotic device module objects. The communication may take place over a network 130.

FIG. 1B illustrates an exemplary distributed robotics device 150 created using the exemplary integrated development environment 100 illustrated in FIG. 1A. The distributed robotics device 150 includes processing units such as robotic device modules 160, 162, 164, 166, 168 and 170 that may communicate with each other over a network 180. The network 180 may support the BCS protocol. Individual modules from among robotic device modules 160, 162, 164, 166, 168 and 170 may be disconnected from the distributed robotics device 150 without impacting the overall execution of the distributed robotics device 150. Similarly, additional robotic device modules may be added to distributed robotics device 150 without affecting the execution of the distributed robotics device/150. The newly added modules automatically introduce themselves as explained herein to the distributed robotics device 150 and start working within the distributed robotics device 150. Control of the distributed robotics device 150 may be distributed among one or more of the robotic device modules 160, 162, 164, 166, 168 and 170 by designating a host module. Connectivity among the components for the distributed robotics device 150 may be ensured by using a heartbeat process. Any module of the distributed robotics device 150 may send a heartbeat signal to other components in the hierarchy. If a component does not respond to the heartbeat signal, the component may be put into a safe mode without disturbing the execution of the overall system. The execution of the distributed robotics device 150 and the communication among the modules are discussed below. The heartbeat signal is also discussed further below.

The embodiments of the present invention allow for a centralized robotics system design with distributed control ability among the components of the robotics system. The foregoing components and processes are explained in detail below.

An important component to a robotics development system is to define a device structure, and define how elements in the structure communicate. For example, for one type of device structure, the system can be designed using one interface module which interfaces with the user's software. The interface module can be replaced with a different module without changing the core algorithm or software-hardware interface if the requirements of the system change within time. Using this framework, if the I/O requirements change, only the I/O controller needs to be swapped out.

Embodiments of the present invention provide a modular, multi-platform, multi-language device interface that features the use of the Bowler Communications System (BCS) protocol, an abstract communication protocol. It will be appreciated that although for ease of illustration reference is made below to the BCS protocol in descriptions of embodiments of the present invention, other abstract communication protocols with substantially similar functionality are also considered to be within the scope of the present invention.

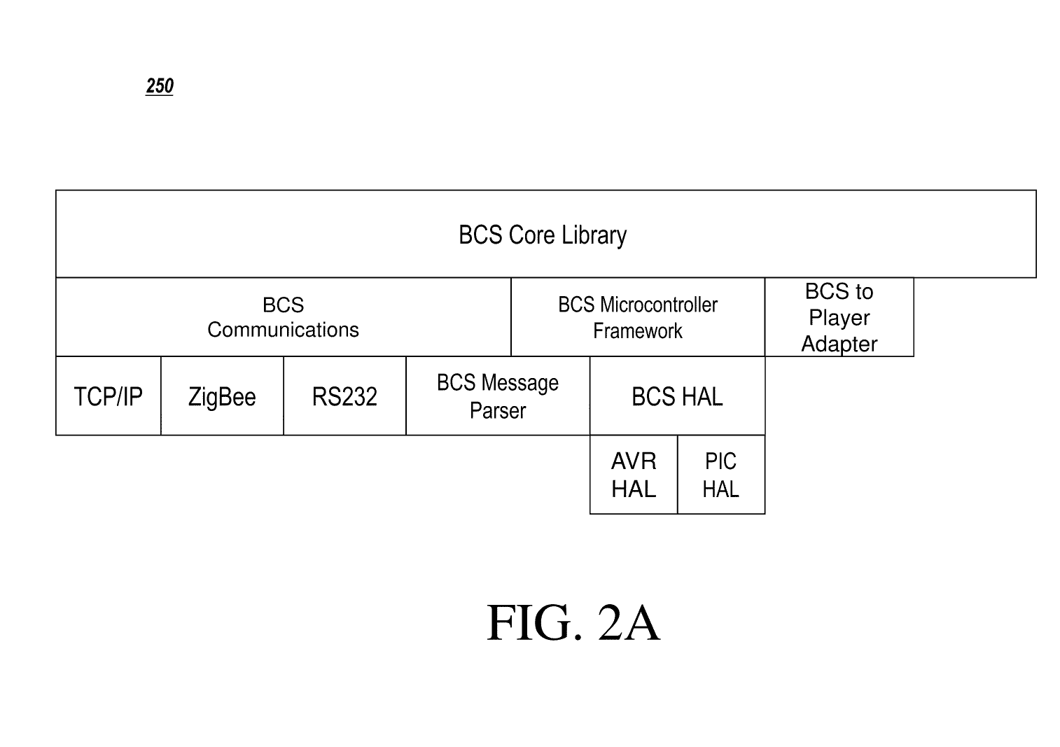

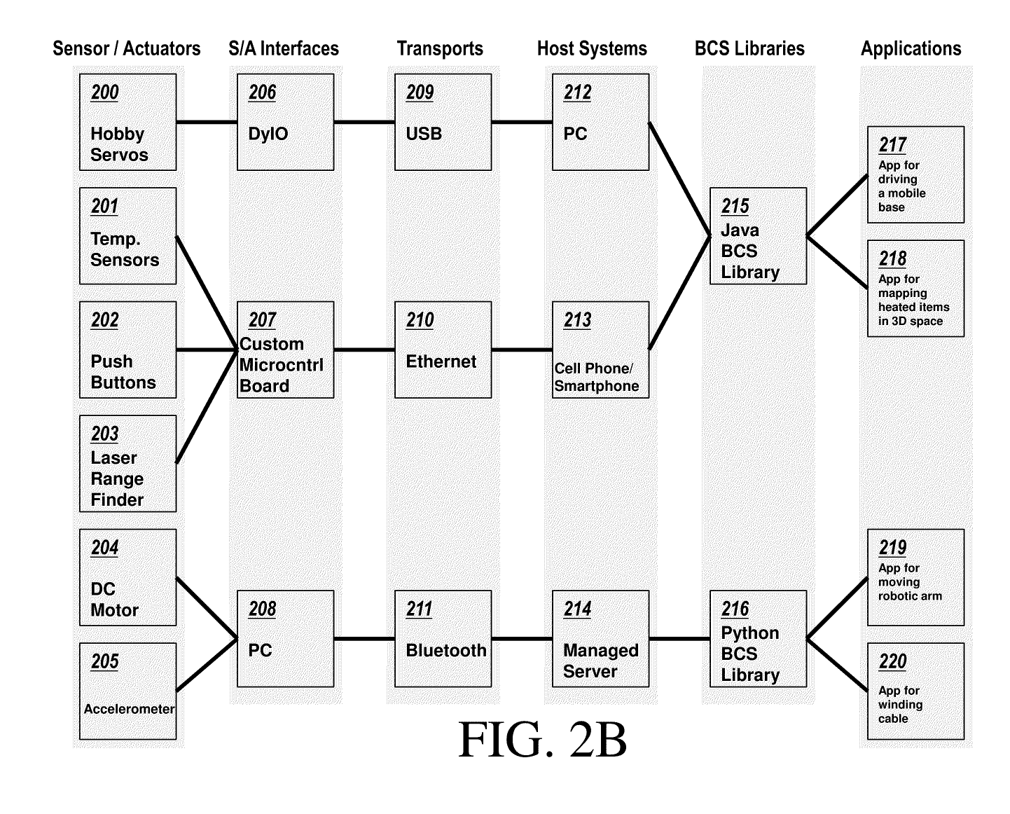

FIG. 2A illustrates an exemplary implementation of the BCS protocol 250 into the modular, multi-platform, multi-language device interface of the present invention. BCS is a series of protocols that regulate communications between the components in a robotics device or CPS. The protocols describe how to format messages between components in such a way as to allow the details of the implementation of each component to be irrelevant to any other component. BCS focuses on configuration over convention. Existing communication systems assumes conventions such as latency, network layer, physical transport and intended processing capabilities of systems with implementation. In contrast, BCS is focused on creating well defined parts that can be configured to fit nearly any situation. BCS is interoperable with different types of hardware components and supports the use of different physical and network layers in communication between components. 8-bit microcontrollers are easily able to use the protocol because BSC is light while at the same time high-powered systems are able to dynamically offer new capabilities.

The BCS protocol 250 is designed to allow for decentralized sensors and actuators or other modules to be utilized in a uniform and reliable manner. A BCS network is based on an asymmetric star topology in which two classes of devices exist: a Host and a Node. Modules are designated as a Host or a Node. In the network, Hosts utilize services provided by connected Nodes to interact with the Node's peripherals devices. A Host communicates requests and Nodes communicate request status and data. An exemplary setup may be a laptop running an application (Host) connected to a servo module (Node) via a USB cable. Hosts may have multiple Nodes while Nodes may have only a single Host. Nodes may act as hosts to other nodes. Routing devices may be used to split a single Nodes connection into multiple Nodes connections. Inter-device communication is accomplished via the BCS protocol and BCS messages. Each Node has a predefined vocabulary of functionality that it implements. Both Hosts and Nodes are capable of decoding a message and determining what actions are necessary as a result.

The BCS protocol governs the datagram structure and transmission rules for carrying the BCS messages. Devices formulate and transmit a datagram in accordance with the BCS protocol. A BCS datagram includes a head and a body. The head is comprised of a number of elements that aid in routing as well as data integrity such as a protocol revision number, the intended recipient's address, a method identifier, a reply flag, a transaction ID, data length field and Cyclic Redundancy Checksum (CRC). The body of the datagram contains the messages that devices will interpret.

According to the BCS protocol, Remote Procedure Call (RPC) messages from the Host are only sent in a synchronous manner in which the Host sends a message and expects a reply within a given amount of time. If a reply message from the Node is not received within the specified amount of time, the Host assumes the message is lost and any response to the initial message after that point is considered to be stale. Nodes, however, have the ability to send messages to the Host either synchronously or asynchronously. Nodes send synchronous messages when replying to a Host. Additionally, a Node may send unprompted, or asynchronous, messages to a Host. Asynchronous messages include error/warning messages when an unexpected event occurs or safety threshold is passed (i.e. a motor overheats, a battery was disconnected, etc. . . . ) or if a Node changes state.

As one example of BCS communication, an application may send a message down a USB connection to a server controller requesting a servo to move to a certain position. The servo controller receives this message, processes it (i.e. move the servo to the requested position) and then sends a return message informing the application of the status of the task (i.e. Successful).

Communications from a Node may be processed messages in any order. As a result, reply messages are not guaranteed to be ordered. To ensure unambiguous communications, a Host may generate a unique Transaction ID and add the Transaction ID to the BCS message. The Node marks any replies, regardless if they are synchronous or asynchronous, with the Transaction ID of the original message. This allows an application attempting to communicate with the Node to map multiple responses to the original requests. A Host may reuse Transaction IDs whenever the Host deems appropriate.

Using the foregoing example, if the application issued a request that a servo temporarily move to a second position from a first position and then, after an amount of time, move back to the first position, the Host may send the request with a generated Globally Unique Identifier (GUID) as the Transaction ID. The module would receive and process the message and send a synchronous reply. The module would then move the servo and send an asynchronous message with the status once the servo has moved to the second position. All the messages, i.e. the message sent by the Host and the two messages sent by the module, would have the same Transaction ID. If there was a sudden failure unrelated to the scope of the initial message, as determined by the servo module (i.e. the battery was running low), the servo module would send an error message with a blank Transaction ID.

All Hosts and Nodes within a BCS network are required to have a unique IEEE EUI-48 Media Access Control (MAC) address. The MAC addresses are used to identify and route communications to devices. In addition to this, a broadcast address is reserved. A device does not distinguish between messages addressed to the device or messages with the broadcast. Routing devices use the broadcast address as their own address and do not implement a valid MAC address.

As noted above, in order to ensure reliable system functionality and safe operation of systems, the BCS utilizes a system heartbeat that will periodically require Nodes to “check-in”. The heartbeat can be used to quickly put sections of or an entire system in a safe operation mode. During initialization, a Host sends a Node a heartbeat trigger message addressed to the broadcast address. The message is marked as critical and indicates that the message should not be interrupted. After performing any safety checks, the Node signifies its proper functionality by responding with a heartbeat acknowledgement message, replacing the broadcast address with its own MAC address. The Host then periodically repeats this process as needed to ensure safe operation. This allows safe and flexible operation as developers can choose the appropriate level of polling needed to determine the health of the Node.

In one embodiment, all Nodes must implement three operating modes: a Normal mode, a Safe mode, and a Full mode. Normal mode is when the Node functions with all possible capabilities. In Normal mode each Node will have a known safe timeout value. This value is the maximum amount of time that a Node will allow between heartbeats before assuming that there has been a loss in communications or functionality and attempts to go into Safe mode. Safe mode is when the device must attempt to act in the safest manner possible with respect to its peripherals (i.e. a motor module may lock motors in position, a servo module may kill power to the servos, etc. . . . ). The device manufacturer publishes what actions that will be taken by a device placed into Safe mode. If the Node is in Safe mode it replies to any heartbeats with notification of the timeout. A Host may bring a Node out of safe mode by sending a reset message. Full mode is when a Node runs as it would in Normal mode but does not timeout. Nodes may not use Full mode as a default mode of operation, but all devices may be put into Full mode, temporarily until hardware reset or power cycle.

The BCS protocol relies on the idea of a tiered processing structure having distinct levels. These levels are discussed below.

The first level of the protocol is the “current through a wire” lowest level hardware interface. This is typically handled by small microcontrollers or Field Programmable Gate Arrays (FPGAs), but may be serviced by hardware ranging from 8-bit microcontrollers up to the most advanced servers. The lowest level takes small packets of bytes as commands with a rigidly defined header followed by a byte stream where the length of the byte stream is described in the header. The header structure allows for the simplest of controllers to take in and process packets without having to do complicated pattern matching or having magic start and/or stop bytes that are forbidden to be sent as raw data. For example, a device manufactured by Neuron Robotics of Worcester, Mass. sends these byte streams over TTL (5-volt logic) level RS-232 structured serial. Information may be encapsulated in a TCP connection or a UDP packet and sent to a corresponding device by a network bridge. Libraries may be built to form and send these packets based on the published protocol specification via serial or over an IP based network. This specific implementation, however, is not intrinsic to the protocol, and is merely a communication protocol that is implemented on a microcontroller allowing any microcontroller to serve as a device at this level. The foregoing example is provided for illustration purposes only and should not be construed as limiting.

A standard set of libraries formulate, verify and propagate BCS communications. JAVA may be used to implement the core of these libraries. Using JAVA enables users to leverage existing projects and techniques for quickly developing upper level applications. The libraries are presented to users in such a manner to make the underlying system transparent as possible. Ideally the libraries do not rely on the host system, but are at the very minimum equally stable with any idiosyncrasies between the major operating systems (Microsoft Windows XP and Windows Vista, Linux 2.6 kernel or higher, Apple OSX 10.5 or higher) hidden to the user. This ultimately allows users to be completely agnostic to the underlying system that they develop on and enhances cross-platform development. Although only the implementation in JAVA is discussed throughout this application, implementation of the communications libraries with a larger selection of languages by the community is also within the scope of the present invention. For example, languages that are popular among roboticists such as C++ and Python as well as languages that are traditionally not associated with robotics development including Scheme, Ruby, and Haskell are within the scope of the present invention.

A component that allows users to freely use, swap, and virtualize hardware is a hardware abstraction layer (HAL). This layer allows vendors to publish interfaces and to subscribe to existing interfaces to enable seamless transition between different hardware implementations with the same functionality. A HAL that is effective specifically for BCS while at the same time being intuitive to users is provided by an embodiment of the present invention. A text-based data interchange such as XML or JSON may be used to create a hardware interface specification. Using a text based data interchange makes it significantly easier for users to directly interact with existing specifications while cutting down development time for machine parsing libraries. Most common languages have existing proven libraries designed for basic parsing of common data interchange formats so specialization of the libraries for the HAL requires using an existing parser and building interfaces via the HAL file for BCS devices. Utilities may be built to allow users direct access live hardware on the network without the need of extensive coding or customization.

FIG. 2B illustrates a system that allows for plug-and-play robotics development through user-developed libraries. Each segment in the system is designed to be optimized specifically for its application. The system as a whole is able to benefit from the optimization because of the standardization of the interfaces and the use of the BCS protocol to tie the high-performance hardware to the general processing system. Sensors and actuators measure and/or interact with a property of the physical world. Hobby servos 200, temperature sensors 201, push buttons 202, laser range finder 203, DC motor 204 and accelerometer 205 are depicted. Each sensor/actuator requires a different physical connection and supporting hardware Sensor/Actuator (S/A) Interface. Exemplary S/A interfaces may include DyIO 206, a custom developed microcontroller board 207 and a standard personal computer 208. The S/A Interface interprets and controls the electrical components required for using the sensors and actuators. Each S/A Interface is connected to the rest of the system though a transport such as, for example, USB 209, Ethernet 210 and Bluetooth 211 are depicted. Each transport manages physical data transportation between systems. In the case of the DyIO 206, the USB transport 209 manages the physical and electrical properties for sending and receiving data. The S/A Interfaces use the Transports to communicate with Host Systems 212, 213, 214. Exemplary Host Systems may include a personal computer 212, a cell phone 213 or a managed server 214. The Host Systems may run applications 217-220, which are built using a BCS library 215, 216. A BCS Library, such as the Java BCS Library 215 or the Python BCS Library 216, enables higher-level languages to process the BCS messages. Applications that use the BCSs libraries may utilize the functions provided to work with the Sensors/Actuators. For example, the application 217 may be an application for driving a mobile base that would control servos 200 attached to a DyIO 206. The application 218 may be an application for mapping heated items in 3D space that would utilize the temperature sensors 201, push buttons 202 and laser range finder 203. The application 219 may be an application for moving a robotic arm. The application 220 may be an application for winding cable.

A community repository may be provided on a community website that allows users to publish HAL description files. Users may use their existing forum profiles to upload BCS files to the repository. The uploading mechanism may validate the format and uniqueness of the submissions.

According to various embodiments of the present invention, a deployable firmware for the VEX™ robotics design system from Innovation First, Inc. that would allow a user to follow the standard firmware update process for the VEX controller is provided. The user may utilize the controller as a BCS device and give full control of the controller's peripherals to a user application on a BCS network by using the firmware and a hardware adapter. Thus, users may deploy and use BCS with systems that they may already have or that can be obtained off the shelf with minimal overhead and costs.

The libraries may be interfaced with different higher level control technologies. For example, the libraries may be interfaced with MATLAB® from The MathWorks Inc. to allow users to connect with a BCS network and pull in sensor data directly. Additionally, libraries may be interfaced with LabView® from National Instruments to enable users to process incoming data directly from BCS devices so as to allow users to manipulate actuators connected via BCS.

The integrated development environment (IDE) of the present invention enables users to access and use BCS hardware in real-time. The Eclipse® platform may be leveraged to build the initial implementation of the IDE as an Eclipse® plug-in. This allows users to more easily adopt the IDE and lowers the entry costs of development with BCS. Keeping in line with the design considerations during the Continuous Computation Language (CCL) development, the IDE may be platform independent to prevent user limitation due to the host systems that they use.

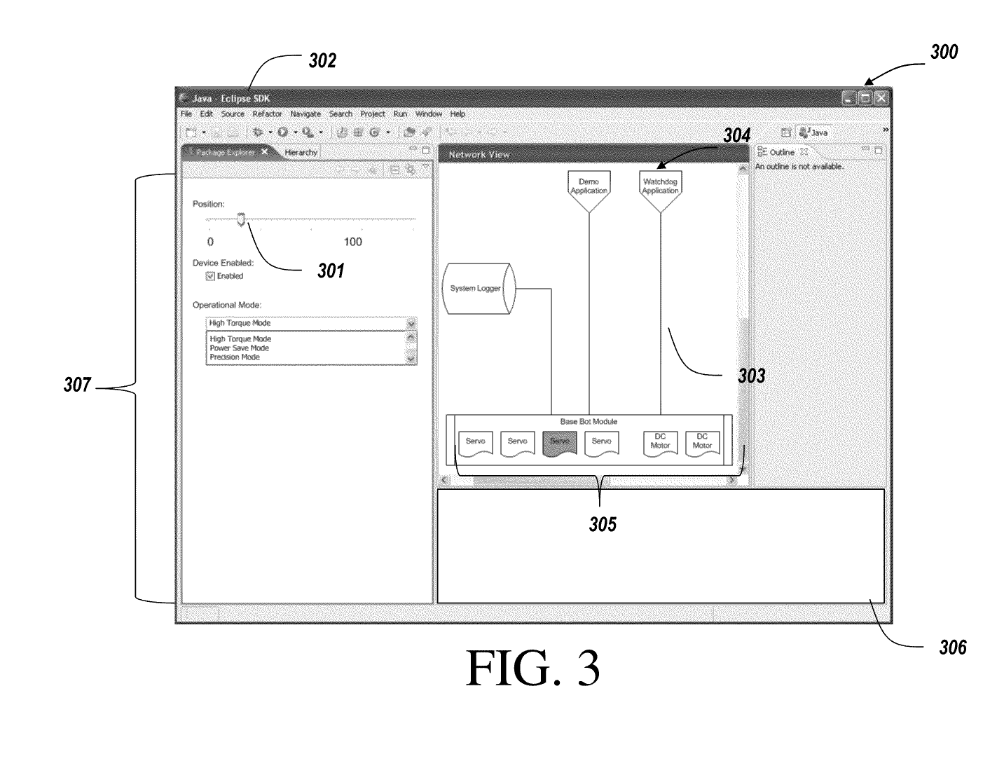

FIG. 3 illustrates a simulated screenshot 300 of the IDE running as a plug-in with the Eclipse platform 302. The screenshot illustrates a component 301 that represents an action or value of the selected device. The frame 302 contains all actions possible on the selected device. The frame 303 contains all of the devices available on a BCS network with their relationships mapped. The screenshot further illustrates a module 304 to a device, e.g. a servo or thermocouple. FIG. 3 further illustrates a module 305, such as a DyIO. The frame 306 contains a console for directly typing in commands and viewing the raw results of actions. The IDE also includes a frame 307, e.g. a graphical user interface, that allows users to interact with BCS devices without the need to write code.

Primary functionalities of the IDE may include among other things the ability to intuitively visualize in real-time BCS compliant modules as they are added and removed from operation, allow for device configuration as necessary, allow users to intuitively interact with the modules in real-time, and present the built libraries such that users can easily access them from within and outside of the IDE.

Users may access a conceptual view of the BCS network to which they are attached. This view may allow users to filter the modules or devices that are displayed based on states of the modules or devices, module or device identifiers and other attributes of the modules or devices. This view may also allow users to conceptually group modules or devices into functional blocks. Although this may not result in any change to the network directly, users may use the view to organize the network as they feel necessary.

Users may select devices or modules from the visualization and configure the modules or devices as appropriate. For example, the user may select a motor controller module. Since this particular module may have a PID controller and implement the PID HAL interface, the IDE would present the user with the ability to set and edit the corresponding gain values for the controller. For the same user, a module may exist that controls a number of servos. When the user selects this module, they are presented with a dialogue that has a number of sliders that correlate to servo position.

A system that allows a user to directly interact with hardware “straight out of the box” with minimal setup is provided. Because the IDE may be a plug-in to Eclipse®, users may go from point and click interactions with hardware to developing scripts and applications from within the same context. This arrangement makes the BCS system available to users ranging from novice to expert and gives all users a common tool to work with. Since the IDE is built using the libraries, users may import the libraries that are outside of the IDE and may move from development within the IDE to a stand-alone application deployment without the need of any additional tools.

According to various aspects of the present invention, an extension to the plug-in that would allow users to interact with non-BCS devices from within the IDE is provided. The extension allows users to fuse the functionality from the different systems with one another at development stage. The extension may allow the BCS IDE to interact directly with industry standard cRIO data acquisition systems and other robot controllers.

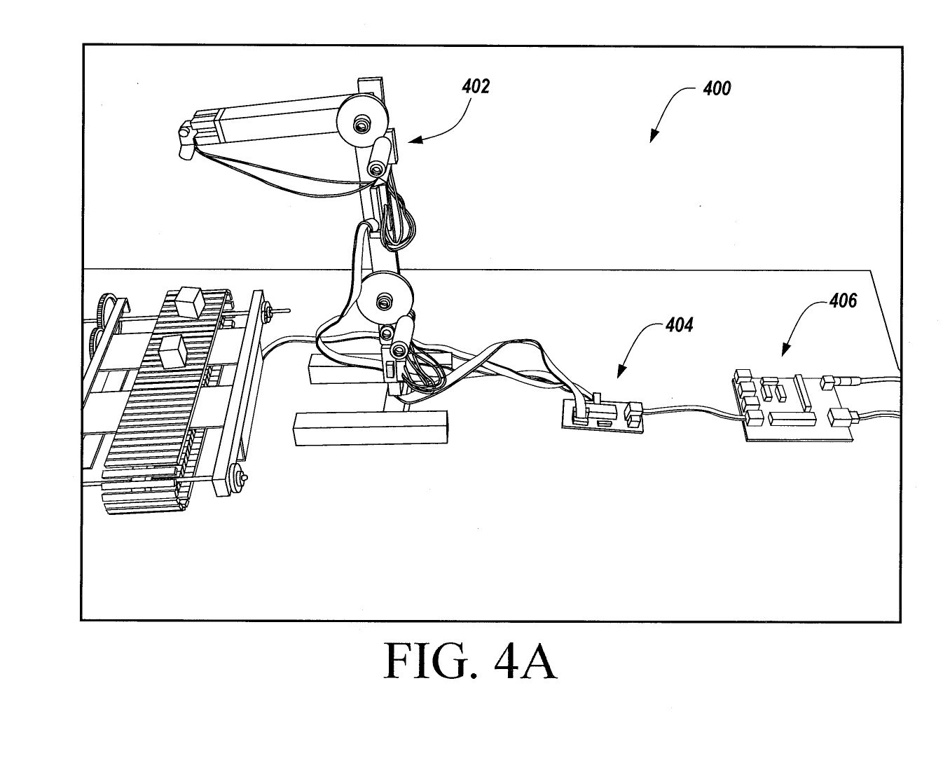

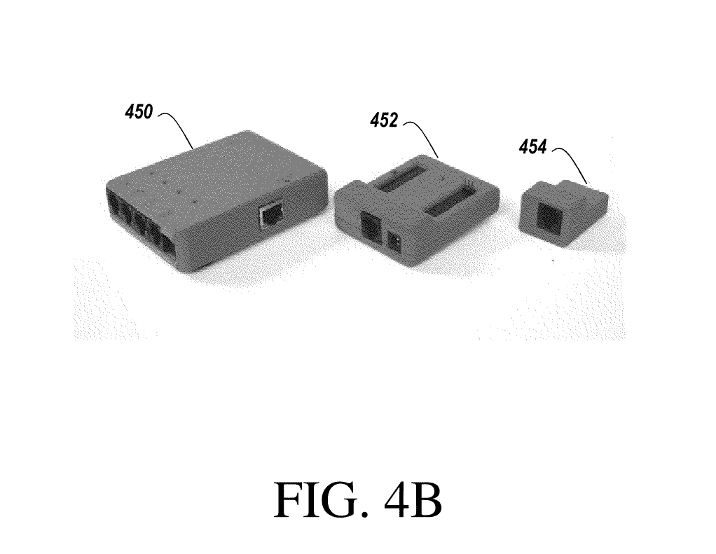

Moreover, multiple BCS modules may be used to control a number of small mobile robotics. These robots may be used to present possibilities of the technology for use with swarm robotics research. An exemplary implementation using the EduArm robot 400 that was developed as a low-cost teaching robot is illustrated in FIG. 4A. The EduArm robot 400 includes a hardware component 402 similar to the hardware component 140 illustrated in FIG. 1A. The hardware component 402 communicates with a robotic device module 404 which receives information for controlling the hardware component 402 through the adapter 406. The exemplary implementation uses the BCS protocol with prototype hardware for controlling an educational robot arm. The ability to work with varying layers of abstraction allows educational modules to focus on specific topics such as robot kinematics, motor control, or high-level planning, independent of other requirements.

The embodiments of the present invention allow modules to be developed to do discrete tasks that are commonly found in robotics such as moving parts of a robot or reading and controlling sensors. The modules communicate with each other and with other devices such as computers and user built modules. Some exemplary modules include a servo controller, a general purpose Input/Output module, a DC motor controller module, a range-finder module, a battery regulator/power module, a USB interface module, a wireless module, and an Ethernet routing module to pull all the modules together. The USB interface module allows users to directly control a module via a USB connection to a computer device. FIG. 4B depicts an exemplary Ethernet module 450, an exemplary servo module 452 and an exemplary USB controller module 454.

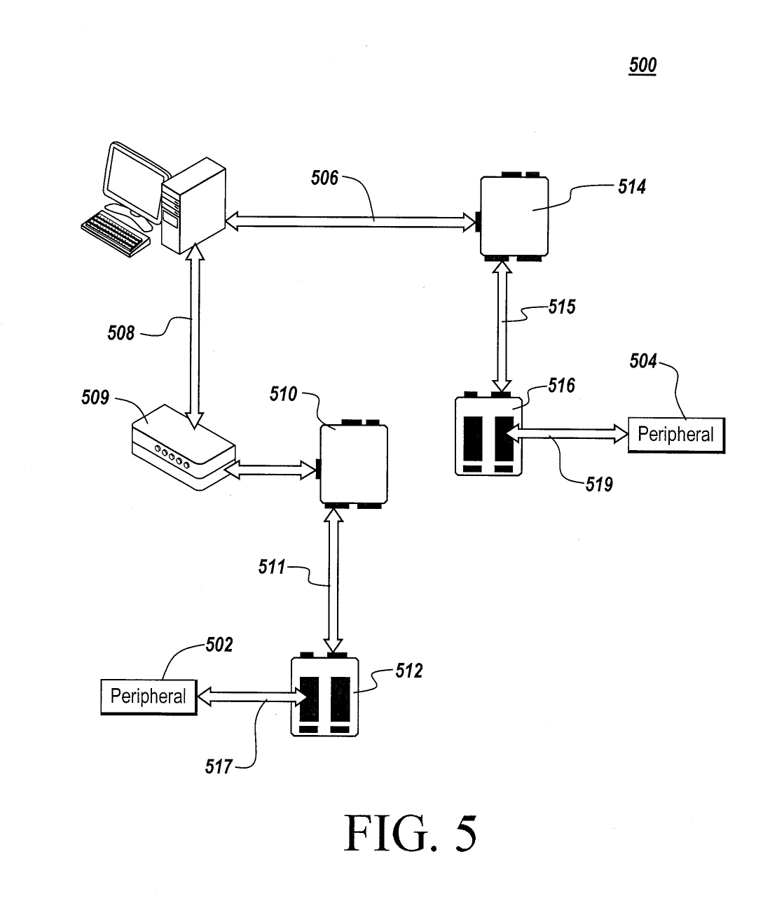

FIG. 5 illustrates a general system overview 500 of the present invention. The system 500 allows users to control peripherals 502 and 504, i.e. individual hardware components such as the hardware component 140 illustrated in FIG. 1A, over a local USB connection 506 as well as over a network connection 508, respectively. A user creates applications with the development platform and the system libraries that can communicate with and control the peripherals 502 and 504 via messages sent using the abstract communication protocol regardless of the network transport layer supported by the peripheral or the physical layer connections employed.

For example, in the example of FIG. 5, when controlled over a network connection, the messages are sent via TCP/IP using a generic network module 509 to the Ethernet module 510. The Ethernet module 510 then determines if the message is addressed to a connected robotic device module 512. If the message is addressed to a connected robotic device module 512, the Ethernet module 510 sends the message to the connected robotic device module 512 via a BCS connection 511. If the message is not addressed to a connected module 512, the Ethernet module 510 lets the sender timeout.

USB 506 connected devices act in the same manner. When a message is sent, the Ethernet module 514 that is controlled over a USB connection 506 determines if there is an appropriate robotic device module 516 waiting. If the robotic device module 516 is waiting, the Ethernet module 514 sends the message to the robotic device module 516 via a BCS connection 515. An advantage to the system is that a module can be removed or relocated in a different position in the system and the system will adapt to this change. The system will allow the user to continue operation without interruption. In the system illustrated in FIG. 5, the control peripherals 502 and 504 are connected to the respective modules 512 and 516 via a wire connection 517 and 519, respectively.

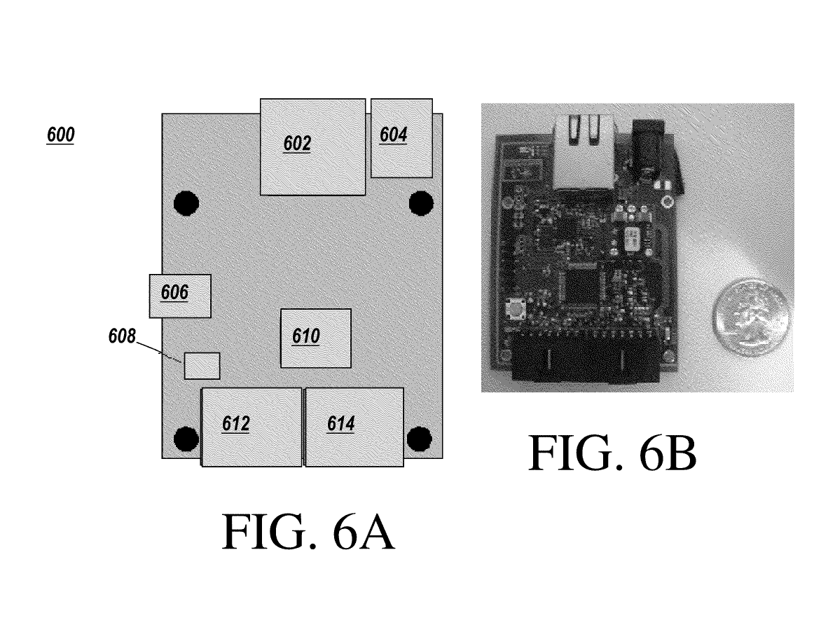

FIG. 6A illustrates an exemplary Ethernet module 600. The Ethernet module 600 includes an RJ-45 Ethernet connection 602, a barrel power jack 604 for external power, a USB mini connection 606, a reset button 608, a microprocessor 610 and a data connection with auto-crossover 612, 614. FIG. 6B illustrates the size of the Ethernet module 600 compared to a U.S. quarter dollar coin.

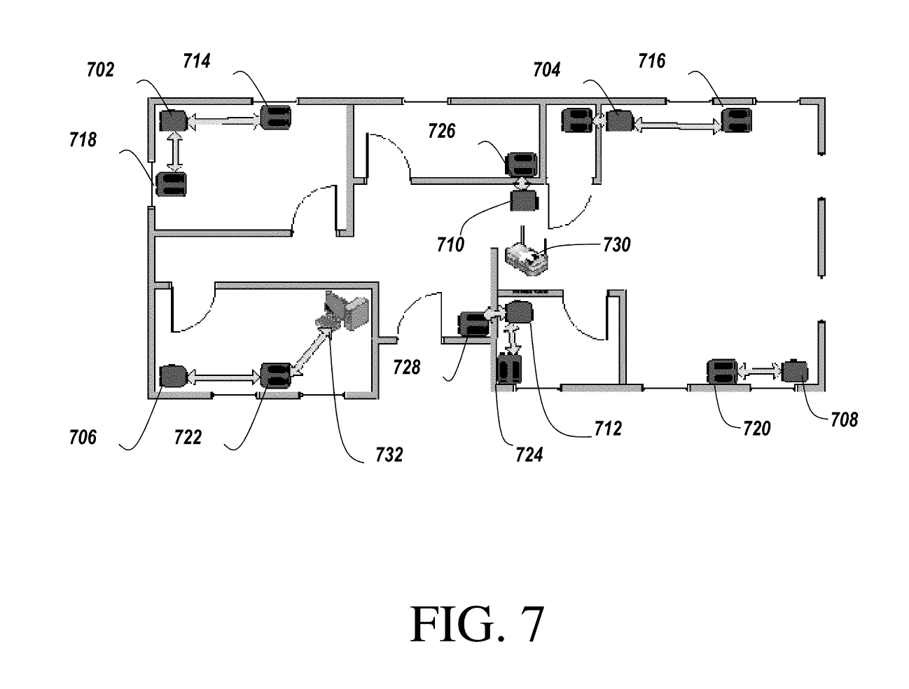

FIG. 7 illustrates an exemplary system use case of a home monitoring system. The sensors are located near windows to gather opening and closing data as well as to monitor data such as temperature. The sensors are connected to the Dynamic Input/Output modules (DyIOs) 702, 704, 706, 708, 710 and 712. The DyIOs are connected to the Ethernet modules 714, 716, 718, 720, 722, 724, 726 and 728, respectively. The Ethernet modules are for the most part connected to a router 730 at the center of the house. The connections with the router may be via Ethernet or may be WiFi based.

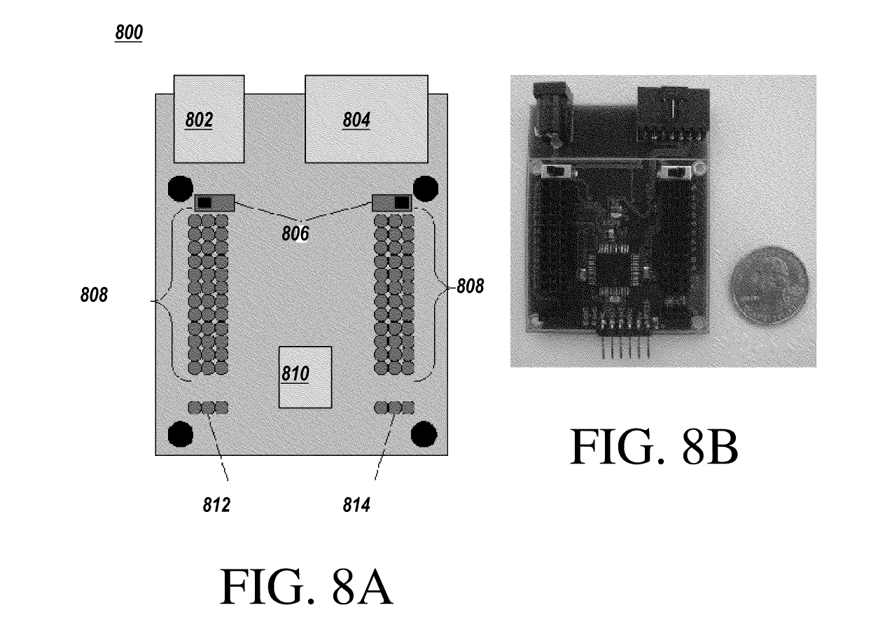

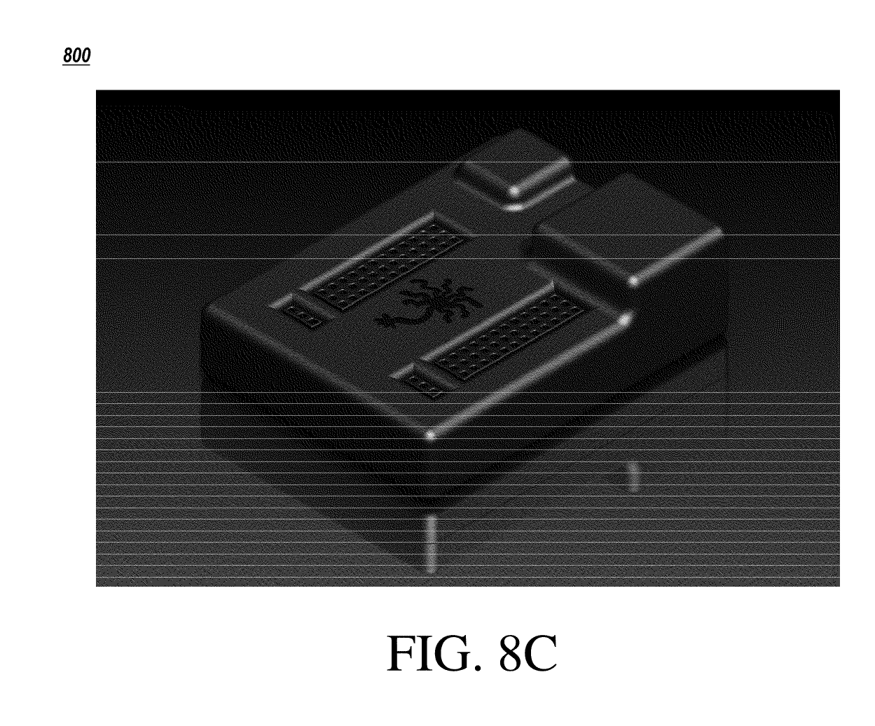

FIG. 8A illustrates an exemplary DyIO 800 structure. The DyIO 800 includes a barrel power jack 802 for external power and seven pin data connection 804. The physical design allows for auto-crossover between devices. The DyIO 800 further includes slide switches 806 that allow user determined power source to channel banks 808. Twelve channel banks 808 are provided on each side of the DyIO 800. Each set of three pins is a separate channel that is capable of multiple operational profiles. The DyIO 800 also includes a microprocessor 810, an external power supply channel 812 and a ground connection channel 814. FIG. 8B illustrates the size of the DyIO 800 compared to a U.S. quarter dollar coin.

FIG. 8C illustrates an exemplary commercial product of DyIO 800.

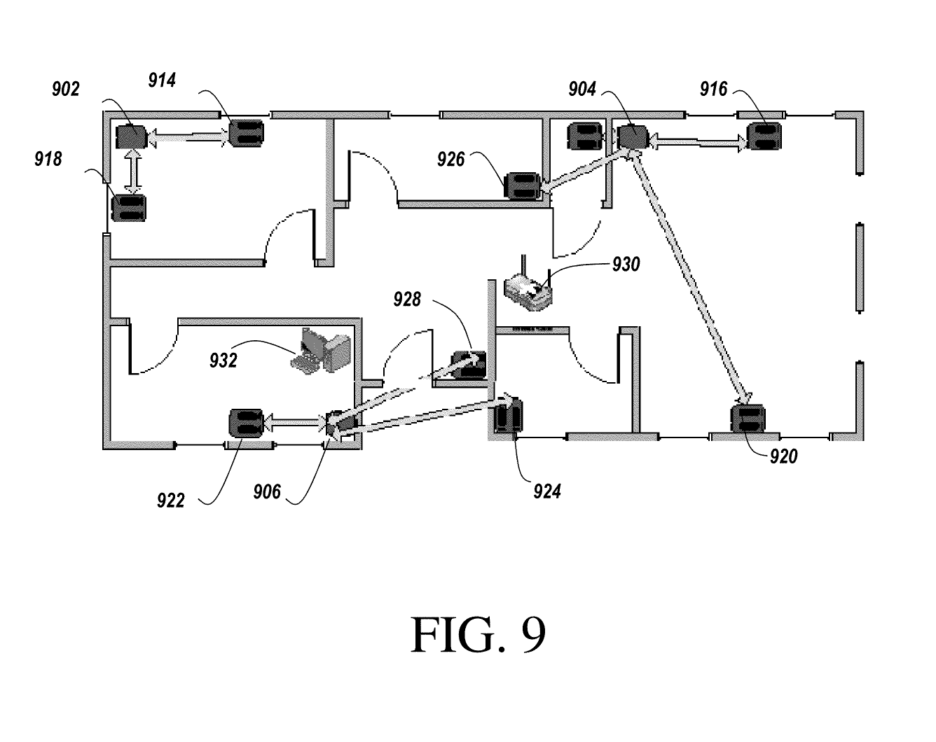

FIG. 9 illustrates an exemplary embodiment of a home monitoring system with wireless connection. In this embodiment the user is monitoring his house by having the modules communicate over ZIGBEE. The sensors are connected to the Dynamic Input/Output modules (DyIOs) 902, 904 and 906. The DyIOs are connected to the Ethernet modules 914, 916, 918, 920, 922, 924, 926 and 928, respectively. The Ethernet modules are for the most part connected to a router 930 at the center of the house. The connections with the router may be via Ethernet or WiFi based. One of the modules 906 is transparently serving as a ZIGBEE to Ethernet bridge.

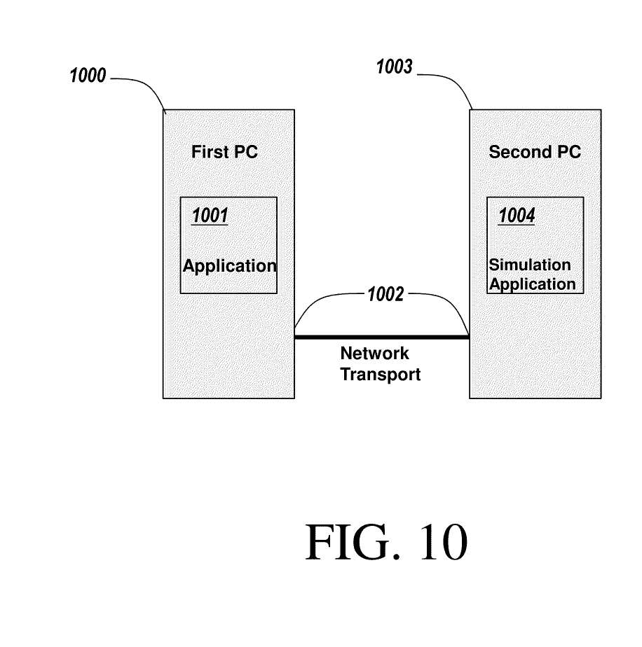

FIG. 10 illustrates an exemplary virtualization according to an embodiment of the present invention. Using network and system abstractions, an exemplary system can simulate the response of a module with peripherals and can act as an emulator. This virtualization allows for users to develop systems without the need of the physical hardware to be available. FIG. 10 illustrates a first personal computer 1000 running a software application 1001. The first personal computer 1000 connects over a network transport 1002 to a second personal computer 1003. A simulation application 1004 on the second personal computer 1003 may model the functionality of a module such as the DyIO and provide responses as though the simulation application 1004 were the module. The software application 1001 makes no differentiation between a physical module and the simulated module. This allows the user to simulate different scenarios in the simulation application 1004 and debug their software application 1001 without the need of a physical module.

The system illustrated in FIG. 10 may be used for testing. With measured inputs and outputs, it is possible to formulate tests. Performance metrics may be determined based on the results of the tests using virtualized hardware. Embodiments of the present invention thus allow unit testing with virtualization at a consumer level to be performed in contrast to conventional techniques used in the robotics development field.

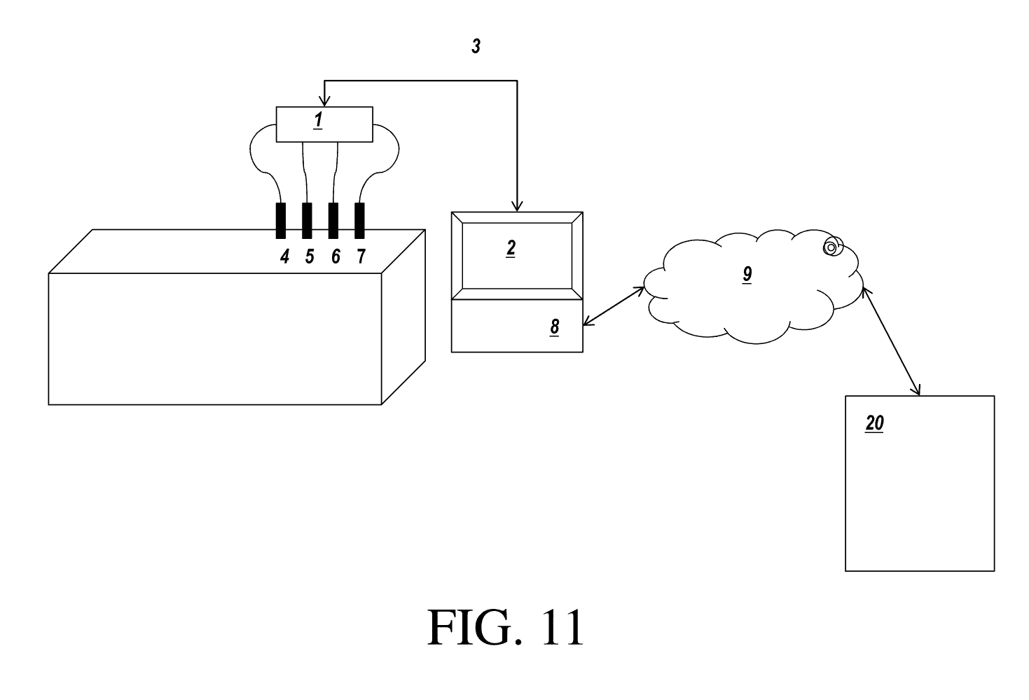

FIG. 11 illustrates an example implementation of a fish monitoring system using BCS modules. DyIO 1 connected to a computing device 2 that is connected to the Internet 9 via a USB connection 3. The computing device 2 is running software 8. The DyIO 1 is also connected to an analog PH sensor 4, an analog temperature sensor 5, a resistive water level sensor 6 and a salinity sensor 7. When the DyIO 1 is connected to the computing device 2 via the USB cable 3, the software 8 and the DyIO 1 communicate over the BCS Protocol. Using this connection, the software 8 is made aware of the capabilities of the DyIO 1. The software 8 then configures the DyIO's analog ports to push values from the analog sensors 4, 5, 6, 7 over the BCS Protocol. The user can then use a language of choice on the computing device 2 to interpret the values from the DyIO 1 and make the computing device 2 perform actions using a wider network service 20 (such as sending a Twitter update or a text message) over the computing device's 2 Internet connection 9.

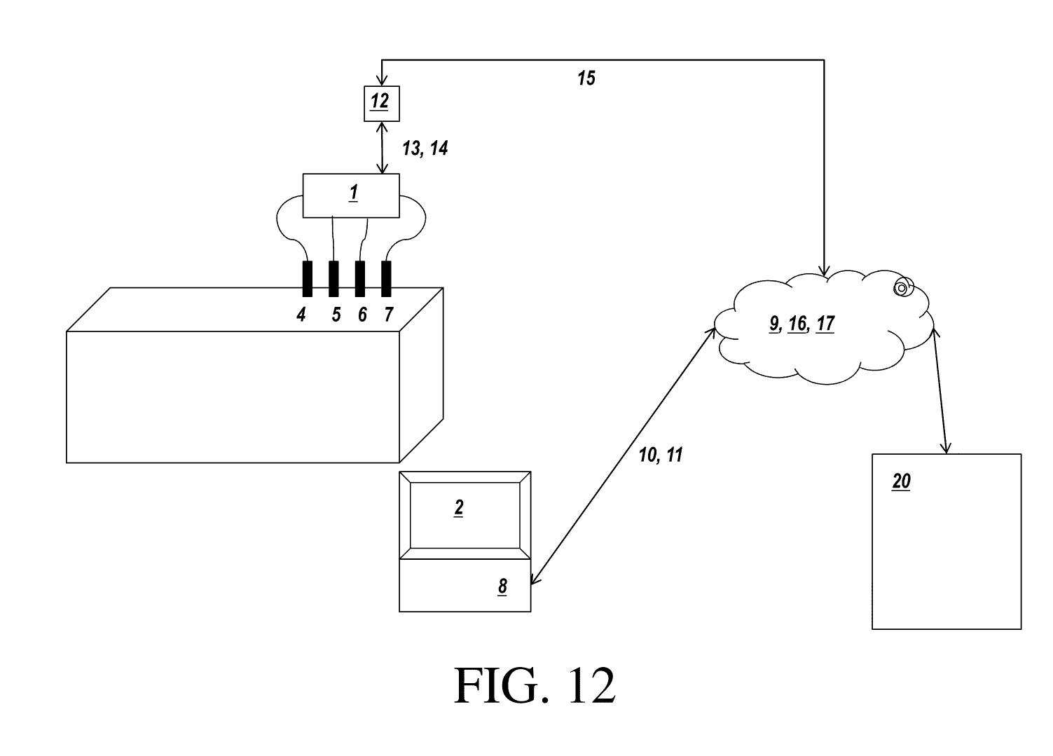

FIG. 12 illustrates the system in FIG. 11 with the addition of an Ethernet routing module 12. If the user wishes to access the sensors from the computing device 2 over the wired LAN 10 connection or the Wireless LAN 11 connection, then the user connects the DyIO 1 to the Ethernet routing module 12 using the DyIO's BCS port 13 and the Ethernet routing module's BCS device port 14. The Ethernet routing module 12 is then connected to the user's wired LAN 10 connection using a BCS device cable 15. The Ethernet routing module 12 is available from the connected computing device 2 and the wireless laptop 16 through the wireless router 17. The user can disconnect the USB connection 3 and use the same software 8 to communicate with the wireless sensors without any change to the software 8. The software 8 can be transferred to the laptop 16 and can interface with the DyIO 1 via the Ethernet routing module 12 and the local network 10, 11, 17.

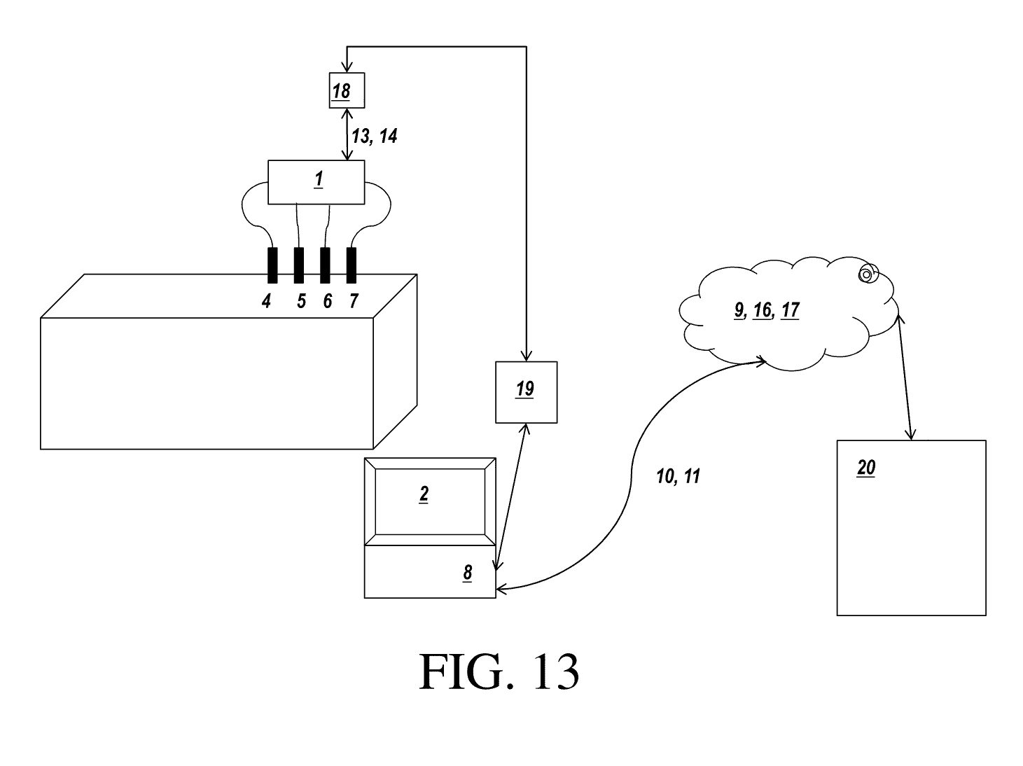

FIG. 13 illustrates a wireless embodiment. If the user wishes to access the DyIO 1 but is unable to connect the DyIO 1 to the computing device 2 via the USB cable 3 or via the Ethernet routing module 12, the user may replace the cable with a pair of wireless adapter modules 18, 19 and continue to use the system without any change to the software.

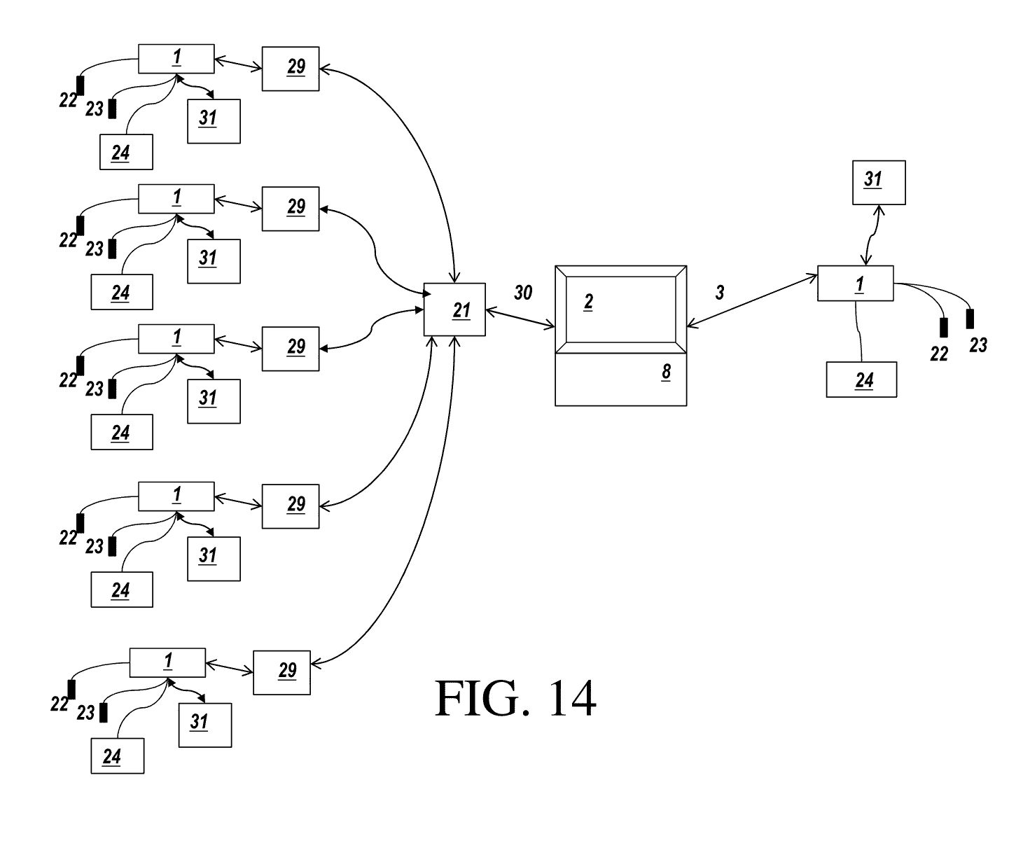

FIG. 14 illustrates a home automation embodiment using a mix of wired and wireless connections in addition to interfacing with existing hardware. The system includes a motion sensor 22, a temperature and humidity sensor 23 and a relay interface board 24 connected to a DyIO 1. This unit is connected to a computing device 2 via a USB connection 3 and is controlled using software 8. The unit is then replicated five times. Each unit is interfaced with a wireless module 29, 21. The computing device 2 communicates with the module 21 using a USB wireless adapter 30. The five replicated units use the same software 8 with no modifications to the software. The units are interfaced with thermostats 31 and allow the user to collect data and control the temperature in the rooms of a house.

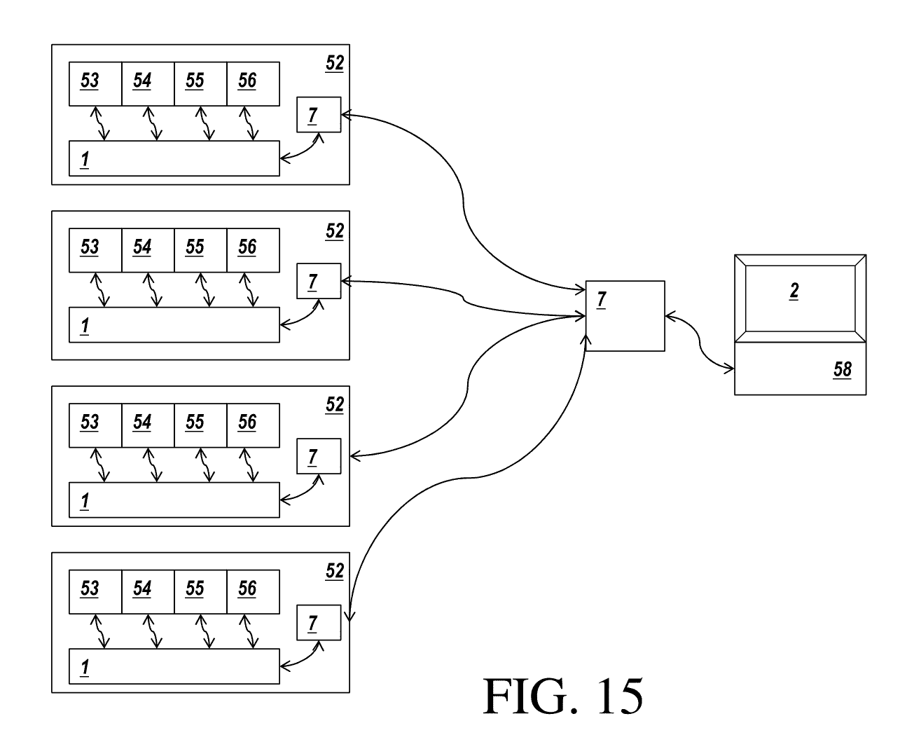

FIG. 15 illustrates an exemplary small robotic arm. The robotic arm includes four actuators 52. Each of the actuators 52 includes a DC motor and driver circuitry 53, a rotational encoder 54, a bound limit sensor 55, and a current sensor 56. The actuators 52 are arranged on the arm in the following order: two actuators 52 at the base for rotation and angle; one actuator 52 at a joint on the arm; and one actuator 52 at a claw at the end of the arm. A DyIO 1 may be used for control. The outputs of each DC motor driver circuitry 53 are connected to GPIO on the DyIO 1. The pins of the GPIO output a PWM signal and a direction signal that the driver circuitry 53 uses to set the speed and direction of the corresponding DC motor. Each of the outputs of the encoder 54 outputting gray code is connected to individual GPIO on the DyIO 1. The limit sensors 55 and the current sensors 56 are connected to GPIO on the DyIO 1.

Each actuator 52 is connected to a computing device 2 over a wireless link 7 and each DyIO 1 is connected to the same wireless modules 7 illustrated in FIGS. 13 and 14. Using an existing software suite 58, four of the DyIO's PID controllers may be configured using existing BCS messages implemented by the DyIO 1 using the BCS protocol. The PID controllers use the sensors and motors 53, 54, 55, 56 to control the position of the actuators 52. The software 58 may send BCS messages to the DyIO 1 to set the position of each actuator 52.

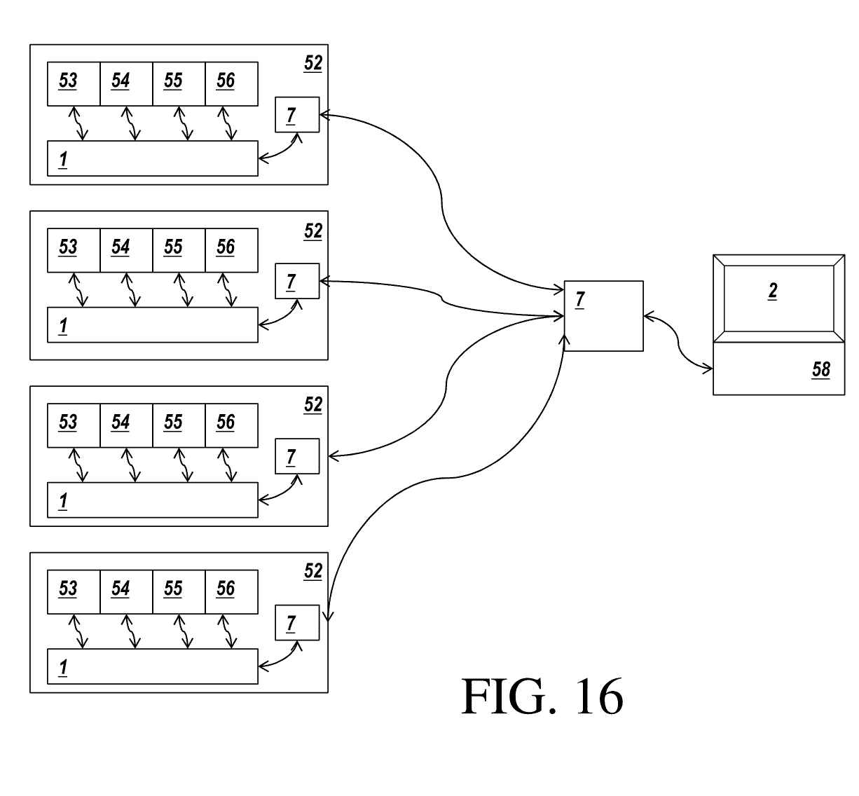

FIG. 16 illustrates creating a new module that is compatible with the BCS. The exemplary robotic arm includes four actuators 52. Each of these actuators 52 includes a DC motor and driver circuitry 53, a rotational encoder 54, a bound limit sensor 55 and a current sensor 56. Using a custom developed microcontroller platform, the user implements a custom HAL that is compliant with an existing BCS core library. An existing BCS microcontroller framework is used to as a basis for the microcontroller platform's firmware and custom BCS messages are added using the framework to allow the user to specify new control actions. An adapter is added for using the BCS device expansion port with the custom solution. The robotic arm is then connected using the same wireless device 7 illustrated in FIGS. 13, 14 and 15. A user may interface with a computing device 2 over the wireless link 7 using the same software 58 from FIG. 15.

An exemplary computing device for practicing the illustrative embodiment of the present invention may take many forms, including but not limited to a workstation, server, network computer, quantum computer, optical computer, bio computer, Internet appliance, mobile device, a pager, a tablet computer, and the like.

The computing device may be electronic and include a Central Processing Unit (CPU), memory, storage, an input control, a modem, a network interface, a display, etc. The CPU controls each component of the computing device. The memory temporarily stores instructions and data and provides them to the CPU so that the CPU operates the computing device. Optionally, the computing device may include multiple CPUs for executing software loaded in the memory, and other programs for controlling system hardware. Each of the CPUs can be a single or multi-core processor.

Embodiments of the present invention may be provided as one or more computer-readable programs embodied on or in one or more mediums. The mediums may be a floppy disk, a hard disk, a compact disc, a digital versatile disc, a flash memory card, a PROM, an MRAM, a RAM, a ROM, or a magnetic tape. In general, the computer-readable programs may be implemented in any programming language. Some examples of languages that can be used include FORTRAN, C, C++, C#, Python or Java. The software programs may be stored on or in one or more mediums as object code. Hardware acceleration may be used and all or a portion of the code may run on a FPGA, an ASIP, or an ASIC. The code may run in a virtualized environment such as in a virtual machine. Multiple virtual machines running the code may be resident on a single processor.

Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

The foregoing description of example embodiments of the invention provides illustration and description, but is not intended to be exhaustive or to limit the invention to the precise form disclosed. Modifications and variations are possible in light of the above teachings or may be acquired from practice of the invention.

We claim:

1. A system for robotics development, the system comprising:
a computing-device generated platform for development of a robotics device, the platform including:
one or more libraries holding a plurality of robotic device module objects defining functionality of associated robotic device modules, the plurality of robotic device module objects including objects associated with at least two different types of robotic device modules, the objects associated with the at least two different types of robotic device modules holding information for communicating with their respective associated robotic device modules; and
an abstract communication protocol supported by instances of the robotic device module objects and used to interconnect the platform and a plurality of robotic device modules, the abstract communication protocol supporting communication over a plurality of different types of physical layer connections and further supporting communication between robotic device modules using a plurality of different types of network transport layer protocols, the robotic device modules respectively controlling a plurality of hardware components for the robotics device.

2. The system of claim 1 wherein the plurality of hardware components include at least one of an actuator, sensor and robotic body part.

3. The system of claim 1 wherein the platform further comprises:
a user interface for constructing the robotics device, the user interface enabling the selection of one of the plurality of robotics device modules, the selection of robotics device module automatically integrating the selected robotics device module into the robotics device being constructed.

4. The system of claim 1 wherein the individual robotics device modules programmatically communicate an interface for communicating with the individual robotic device module to a controlling host.

5. The system of claim 1 wherein the platform further comprises:
a graphical display depicting the current operational status of the plurality of hardware components and associated robotics device modules making up the robotics device.

6. The system of claim 1 wherein the at least two robotics device modules of different types include at least two of a servo controller module, a general purpose Input/Output module, a DC motor controller module, a range-finder module, a battery regulator/power module, a wireless interface module and an Ethernet interface module.

7. A method for operating a distributed robotics development system, the method comprising:
providing a platform for development of a robotics device including a plurality of robotic device modules, the platform including:
one or more libraries holding a plurality of robotic device module objects defining functionality of associated robotic device modules, instances of the robotic device module objects supporting the use of an abstract communication protocol to interconnect the platform and a plurality of robotic device modules of the robotics device, the abstract communication protocol supporting communication over a plurality of different types of physical layer connections and further supporting communication between robotic device modules using a plurality of different types of network transport layer protocols;
designating with the platform a host to control at least one robotics device module in the robotics device, the at least one robotics device module designated as a node;
receiving at the host a communication from the node, the communication using the abstract communication protocol and describing an interface for the node;
transmitting a command from the host to the node, the command directed to a hardware component associated with the node; and
receiving, at the host, a result of an attempted execution of the command from the node.

8. The method of claim 7, further comprising:
creating the robotics device using the platform.

9. The method of claim 7, further comprising:
adding or removing a robotics device module to/from the robotics device with the platform.

10. The method of claim 7, further comprising:
receiving at the platform, data from the host.

11. The method of claim 10 wherein the data from the node is processed by a computing module in communication with the platform.

12. The method of claim 7, further comprising:
transmitting communications between the host and the at least one node over a network.

13. The method of claim 7 wherein the node is associated with and controls at least one of an actuator, sensor and robotic body part.

14. The method of claim 7 wherein the plurality of robotic device modules are organized in a hierarchical structure in the distributed robotics system.

15. The method of claim 14 wherein at least one of the plurality of robotic device modules includes one or more sub-robotic modules.

16. A non-transitory computer-readable medium holding computer-executable instructions that when executed cause at least one computing device to:
provide a platform for development of a robotics device including a plurality of robotic device modules, the platform including:
one or more libraries holding a plurality of robotic device module objects defining functionality of associated robotic device modules, instances of the robotic device module objects supporting the use of an abstract communication protocol to interconnect the platform and a plurality of robotic device modules of the robotics device, the abstract communication protocol supporting communication over a plurality of different types of physical layer connections and further supporting communication between robotic device modules using a plurality of different types of network transport layer protocols;
designate with the platform a host to control at least one robotics device module in the robotics device, the at least one robotics device module designated as a node;
receive at the host a communication from the node, the communication using the abstract communication protocol and describing an interface for the node;
transmit a command from the host to the node, the command directed to a hardware component associated with the node; and
receive, at the host, a result of an attempted execution of the command from the node.

17. The medium of claim 16, wherein the instructions when executed further cause the at least one computing device to:
create the robotics device using the platform.

18. The medium of claim 16 wherein the instructions when executed further cause the at least one computing device to:
add or remove a robotics device module to/from the robotics device with the platform.

19. The medium of claim 16 wherein the instructions when executed further cause the at least one computing device to:
receive at the platform, data from the host.

20. The medium of claim 19 wherein the data from the node is processed by a computing module in communication with the platform.

21. The medium of claim 16 wherein the instructions when executed further cause the at least one computing device to:
transmit communications between the host and the at least one node over a network.

22. The medium of claim 16 wherein the node is associated with and controls at least one of an actuator, sensor and robotic body part.

23. The medium of claim 16 wherein the plurality of robotic device modules are organized in a hierarchical structure in the distributed robotics system.

24. The medium of claim 23 wherein at least one of the plurality of robotic device modules includes one or more sub-robotic modules.

25. A method for performing unit testing in a robotics development system, the method comprising:
providing a platform for development of a robotics device including a plurality of robotic device modules, the platform including:
one or more libraries holding a plurality of robotic device module objects defining functionality of associated robotic device modules, instances of the robotic device module objects supporting the use of an abstract communication protocol to interconnect the platform and a plurality of robotic device modules of the robotics device, the abstract communication protocol supporting communication over a plurality of different types of physical layer connections and further supporting communication between robotic device modules using a plurality of different types of network transport layer protocols;
designating with the platform a host to control at least one robotics device module in the robotics device, the at least one robotics device module designated as a node, the node controlling a computing resource simulating the performance of virtual hardware component in the robotics device;
receiving at the host a communication from the node, the communication using the abstract communication protocol and describing an interface for the node;
transmitting a command from the host to the node, the command directed to the virtual hardware component associated with the node;
receiving, at the host from the node, a result of the simulated execution of the command by the computing resource; and
evaluating with the platform the performance of the virtual hardware component in the robotics device.

26. The method of claim 25 wherein the computing resource simulates the performance of an actuator, sensor and robotic body part.

27. A system for a cyber-physical system development, the system comprising:
a computing-device generated platform for development of a cyber-physical system (CPS), the platform including:
one or more libraries holding a plurality of CPS module objects defining functionality of associated CPS modules, the plurality of CPS module objects including objects associated with at least two different types of CPS modules, the objects associated with the at least two different types of CPS modules holding information for communicating with their respective associated CPS modules; and
an abstract communication protocol supported by instances of the CPS module objects and used to interconnect the platform and a plurality of CPS modules, the abstract communication protocol supporting communication over a plurality of different types of physical layer connections and further supporting communication between CPS modules using a plurality of different types of network transport layer protocols, the CPS modules respectively controlling a plurality of hardware components for the CPS system.
